(19) United States
(12) Patent Application Publication
(10) Pub. No.: US 2004/0236590 A1
(43) Pub. Date: Nov. 25, 2004

(54) Method and system for simplifying activation of a device and a device activated acccording to such method

(76) Inventor: Michael Maria Visser, Lt Gouda (NL)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/487,159

(22) PCT Filed: Aug. 26, 2002
(86) PCT No.: PCT/EP02/09523

(30) Foreign Application Priority Data
Aug. 29, 2001 (NL) 1018846

(51) Int. Cl. G06F 17/60

(52) U.S. Cl. 705/1

(57) ABSTRACT

The invention pertains to a method and a system for simplifying the activation of an obtained device. This simplification is accomplished by coupling pre-existing details of users to a network identifier of the obtained device. In this way the charging for services used by the user can take place in a simple way, and the user interface of the obtained device can be personalized.

### BACKGROUND OF THE INVENTION

The invention pertains to a method for simplifying activation of an obtained device to allow a user to take services from a service provider. The invention also concerns a system that has means for executing the method according to the invention and further includes devices activated according to the method. In particular, the simplified activation of the obtained device according to the invention concerns simplification of the way in which charging occurs for services provided to the user and the way an obtained device is configured at the time of activation.

At present, there are in principle two methods for charging for services taken from a service provider. The first method is the “prepaid” variant whereby the user purchases a device, and independently of that purchase, obtains a credit allowing services to be purchased from a service provider. A credit of this kind will typically consist of a number of time units during which the user may take the service. For this purpose, the user pays a charge in advance. Once the credit has been used up, the user may obtain a new credit in order again to take services from a service provider. With this prepaid variant, it is possible for the device and the credit to be obtained from different parties.

The second method is the “postpaid” or subscription variant, whereby the user obtains a device with a network identifier (e.g. based on a fixed physical connection (CLI) or a mobile connection via a Subscriber Identification Module (SIM)) and must further provide details that enable the service provider to charge the user for the services taken. It is known that, in the case of devices with separate subscriptions, the use made of services by means of such devices is itemized on a bill. If use is made of the measures according to the invention, it will be possible automatically to configure the user interface and the services purchasable with an obtained device in accordance with the personal preferences of a user. It is known that user interfaces can be personalized, whereby recognition by a system of a combination of user name and user password causes an interface once set by the user to be retained and re-presented to the user in subsequent sessions. Another possibility is defined in European patent application EP 0 793 170, whereby the user makes known the desired configuration of a device to the seller of the device at time of its purchase. On activation, the device can send a request on the basis of which a connection can be established with a service provider.

The known methods of service charging and personalization have a number of disadvantages. A disadvantage of the prepaid charging variant is that, at a certain time, the credit is no longer sufficient to allow use of the services of a service provider. The user must then top up the credit. This repeatedly requires an action by the user before the user is again able to take services. A further disadvantage of the prepaid charging variant is the circumstance that no details are known of the user, a circumstance that impedes personalization of the user interface and the purchasable services according to the measures of the invention.

A disadvantage of the postpaid or subscription variant is that when obtaining the device the user must provide details to allow use of the service to be charged to the user. These details must be made known to the service provider to allow the user to be charged for the provided services. In practice, therefore, devices whereby charging takes place based on the subscription variant are usually provided only by the service provider himself, and only in a limited number of cases via sales outlets independent of the service provider. After all, it will be cumbersome for subscription device suppliers who are independent of the service provider repeatedly to register and pass on user details to the service provider. The known combination of subscriptions of different devices on a bill has the disadvantage that, when the devices are obtained, each must first have an individual subscription before being combinable.

Personalization using a combination of user name and password requires entry of both of these fields. This is cumbersome. If a mobile phone is used, for example, authorization of the user will already have occurred via the SIM and subsequent entry of a user name and password is superfluous.

A disadvantage of automatic configuration of a device purchased by a user from a seller, as described in European patent application EP 793 170, is that on each subsequent purchase of a device it is necessary to inform the seller of the new device of the required configuration. Also, patent application EP 793 170 does not provide a method, after contact has been established with a service provider, for offering the user of the obtained device a personalized user interface and personalized purchasable services. Furthermore, the method defined in patent application EP 793 170 requires the presence of an extra configuration server from which the configuration data must be sent to the obtained device to allow a connection to be established with a service provider.

### SUMMARY OF THE INVENTION

The method, system and device of according to the invention offer a new and inventive solution to the problems of the prior art discussed above. According to the method and the system, a network identifier of an obtained device is coupled to pre-existing details of users. These may include, for example, details already available via a pre-existing payment relationship for a device obtained earlier from a service provider. An obtained or obtainable device may be, for example, a mobile phone or a personal computer, but in principle any type of device on which a service provider can offer services. The services may include all kinds of information services (weather, traffic, recipes and similar), and also configuration services, advertising and similar.

It is also possible that the details will be known to a third party, possibly a party unrelated to the service provider, whereby the pre-existing payment relationship consists, for example, of a subscription to a newspaper or an account held with a bank. This third party will then inform the service provider that the services the service provider provides to the user must be billed by means of the newspaper subscription or bank account. The method and system according to the invention also offer a possibility to charge for some of the services provided by the service provider by means of a pre-existing subscription with a service provider and others by means of a subscription with the third party. This could include, for example, the possibility to charge for business use of the obtained device via a business subscription and for private use of the obtained device via a newspaper subscription or bank account. According to the invention, it is further possible to settle up for services with different third parties, for example, with some services taken by the user being charged by means of the newspaper subscription and others by means of a bank account. Another possibility is, for example, for services used during certain hours of the day to be charged via a first third party and those used during other hours of the day via a second third party. According to the invention, it is further possible for the service provider to inform the third party with whom the user of the obtained device already has a pre-existing payment relationship that the services (or some of them) must be billed via the subscription with the third party.

The method and system according to the invention also include a possibility to configure the user interface of the obtained device, and the services to be taken with it, by means of a preferred profile already made known by the user. This possibility will exist, for example, if a payment relationship for a previously obtained device already exists with the service provider and a preferred profile is already known for the previously obtained device. In this situation, the service provider already has both a coupling between the network identifier and the details of the user and a coupling between the details of the user and the preferred profile for the previously obtained device. Therefore, it is possible to use the network identifier of the obtained device automatically to configure the user interface and the purchasable services. It is unnecessary to make known separately the wishes regarding the configuration of the new device at the time of its purchase. Moreover, using the method according to the invention, it is possible to change the user interface and purchasable services of all devices of the user in one go if, for example, the user requests such changes or if a certain service is no longer active.

It will be clear to an expert that the disadvantages of the prior art do not:occur with the method and system according to the invention. The disadvantages of the prepaid charging variant have been solved because it is unnecessary for the user to top up the credit as charging will take place by means of a pre-existing payment relationship. The disadvantage of the conventional postpaid or subscription variant does not occur with the invention because the device supplier no longer needs to register the user's details and pass them on to the service provider. In other words, the invention makes it possible to provide devices without the user needing to come into contact with the service provider in any way whatsoever, or at least the user does not need to make known his details to the service provider, yet the details for charging services are nevertheless already known to the service provider. By coupling the network identifier and the user's details according to the invention, it is also possible to configure the user interface of an obtained device by means of a previously disclosed profile, thus rendering superfluous the use of a user name and password.

### BRIEF DESCRIPTIONS OF THE DRAWINGS

FIGS. 1A and 1B concern examples of embodiments of possible steps in the method.

FIG. 2 is a diagrammatic representation of an embodiment example according to the invention for the configuration of the user interface.

FIG. 3 shows an example of roles the parties concerned may fulfill and the different relationships between the individual roles.

### DESCRIPTION

An example will be used to describe some preferred embodiments of the method, system and a device according to the invention. It will be clear to experts that alternative or equivalent embodiments of the invention are conceivable and practicable without departing from the fundamentals of the invention. These fundamentals will be limited only by the claims as ultimately granted.

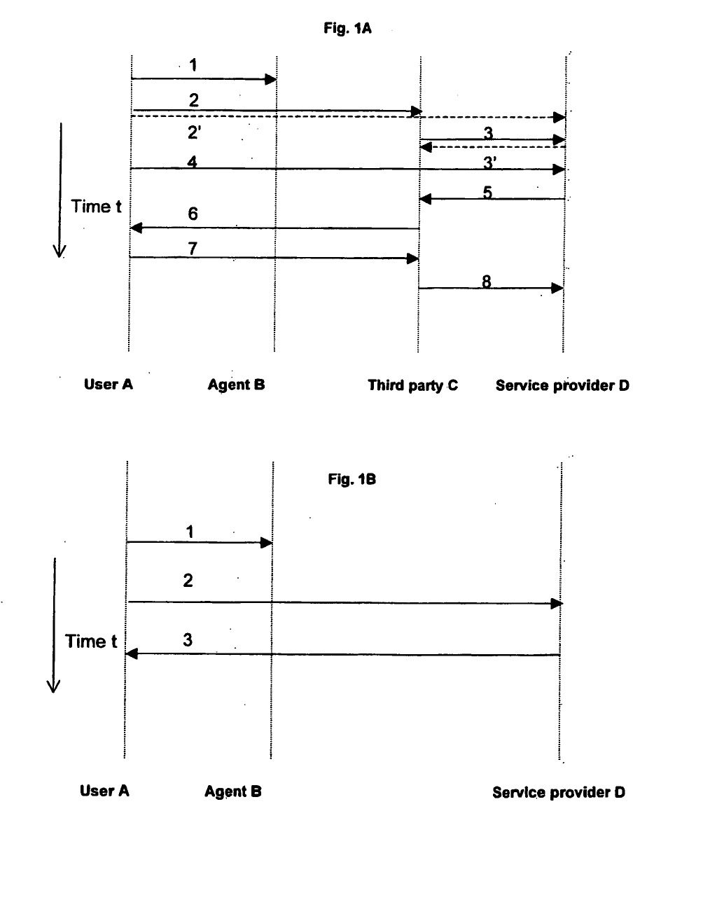

FIGS. 1A and 1B show examples of possible steps with the method and the system according to the invention. It is assumed that the user's details are already known in some way to a third party (C). It is possible, for example, that the third party (C) already has a payment relationship with the user (A) of the obtained device because (C) is a publisher with whom (A) has a subscription to a newspaper or magazine or, for example, a bank at which (A) holds an account. The third party (C) may also be another service provider with whom user (A) has a subscription for use of services by means of a previously obtained device. It is also possible for party (C) to be the same as the service provider (D). This could be, for example, a telecom operator with whom (A) already has a subscription for a previously obtained device or fixed telephone line. The process shown in FIG. 1A takes place in the following way. With regard to this example, FIG. 1A shows horizontally the parties involved and the interaction between them in the various steps, and vertically the time. In step 1A, the user (A) obtains a device from an arbitrary agent (B). The status of the obtained device at this stage is definable as “subscription seeking”, which means that no services can yet be taken by means of the obtained device, or only services paid for by means of the prepaid variant. Agent (B) may be a shop where the device was purchased, rented, leased, borrowed, etc. Agent (B) will preferably no longer be involved in the process.

In step 2, the user (A) informs third party (C), who already knows his details for example because of a pre-existing payment relationship, that he wants this third party to charge him for use of services taken from service provider (D) by means of the obtained device. If (C) is a publisher, use of the service can be charged, for example, by means of the payment made for a subscription to a magazine. If (C) is a bank, payment for use of the service can be debited directly to the account of user (A) with the bank. As an alternative (see dotted line, step 2 in FIG. 1A), the user (A) can inform service provider (D) that payment for services provided by (D) will take place by means of a pre-existing payment relationship with third party (C). The notification given by the user (A) to third party (C), or alternatively to service provider (D), consists of at least a network identifier of the obtained device together with details the user (A) used to identify and preferably also authenticate himself. The network identifier can be passed on in numerous different ways. It is conceivable, for example, that the user will log on to a remote system of the third party (C), or alternatively service provider (D), in order to make known a telephone number of an obtained telephone device, for example. Similarly, it is conceivable that the user (A) communicates with (C), or alternatively (D), by means of a device with an existing subscription, whereby (C) or (D) identifies the user by means of the CLI after which the user passes on the network identifier of the obtained device.

In step 3, third party (C) informs the service provider (D) that he will pay for the services provided by (D) by means of a pre-existing payment relationship in the form of, for example, a subscription or an account that the user (A) already has with (C). In the alternative case (see dotted line, step 3, FIG. 1A), the service provider (D) informs third party (C) that the services provided by (D) will be billed by means of the subscription with (C). At this stage, the status of the obtained device is definable as “subscription sharing”. It is also possible for only some of the services to be settled up with third party (C) while others are settled up with the service provider (D). This method could be used, for example, to separate business costs from private costs incurred for use of the obtained device and related services. It is conceivable that the private costs will be charged to a bank account that the user (A) holds with bank (C), while the business costs incurred for use of the device will be charged directly to a subscription with the service provider (D). It is also possible for the user (A) to maintain relations with several parties (C), whereby each party (C) charges (A) for some of the costs of the services provided by the service provider (D) to (A). In such a situation, the service provider (D) can also inform third parties (C) that the services provided by (D) will be settled up by means of subscriptions or accounts with those parties (C). Numerous modifications of the given examples will be conceivable by experts and the invention also covers such modifications. In step 4, the user (A) uses the services provided by the service provider (D), for example telecommunications services, Internet services, content services or other services for which a device is needed.

In step 5, the service provider (D) informs third party (C) what must be charged for the services that (D) provides to the user (A). Step 3 can, in the alternative case, coincide with step 5.

In step 6, third party (C) settles up with the user (A) via the pre-existing payment relationship in the form of, for example, a subscription or current account.

In step 7, the user (A) pays the third party (C) the amount owed for his use of the services provided by the service provider (D). This payment may take place automatically or manually.

In step 8, third party (C) pays service provider (D) the amount owed for the use that the user (A) made of the services. In this context, it is conceivable that third party (C) may receive a certain fee for making available the existing payment relationship between third party (C) and user (A) for settling up for the services that the service provider (D) provider to the user (A). If the third party (C) is a bank, for example, it is conceivable that the third party will receive an extra fee for making available the pre-existing payment relationship, in return for the great degree of certainty that payment will actually take place.

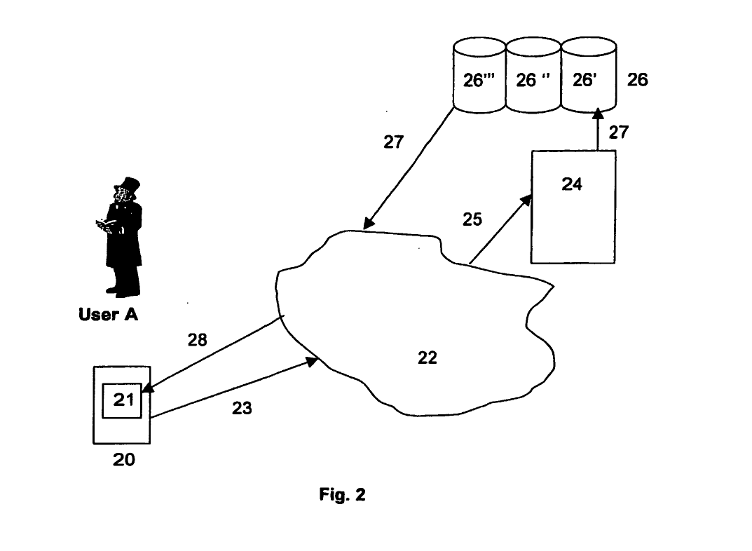

FIG. 1B shows an example in a situation where the third party (C) is the same as the service provider (D). Here again, step 1 concerns obtaining the device from agent (B). In step 2, the user (A) identifies himself to the service provider (D) and makes know to the service provider (D) the network identifier of the obtained device. In this situation, the existing payment relationship with (D), based on a previously obtained device for example, can be used to settle up for the use made of services via the obtained device. A further possibility exists automatically to configure the user interface of the obtained device and the purchasable services according to a preferred profile that became known earlier to the service provider. This preferred profile may be known to the service provider because, for example, the user (A) had previously made known to the service provider (D) a preferred profile for the previously obtained device. FIG. 1B shows, as step 3, the automatic configuration of the user interface and the purchasable services, as elaborated further in FIG. 2. Note that automatic configuration of the user interface can also take place, in principle, if a third party (C) is involved in addition to the service provider (D). In that case, it is desirable for the databases of the third party (C) and the service provider (D) to be harmonized with each other in some way.

FIG. 2 is a diagrammatic representation of a possibility for configuring the user interface of the obtained device and the purchasable services by means of an already known personal preferred profile of the user (A). The device (20) that (A) wishes to use to take certain services contains a user interface (21). When the device (20) is activated, it seeks contact with a network (22) as represented by (23). The search for contact with the network (22) can take place manually or automatically after activation of the device (20). A server (24) of the service provider (D) recognizes the network identifier of the device (20), as represented by (25). A database (26) of service provider (D) contains details of the network identifier (26′) and the details of the user (26″), as obtained in step 2 and shown in FIG. 1B. Based on a pre-existing payment relationship between the user (A) and the service provider (D), details will preferably be known of user (A) as regards the method of payment for services taken by the user (A) with a previously obtained device, and also the way in which the user interface of the previously obtained device and the services taken with it was configured (26′″). The customer will preferably have-indicated this earlier configuration based on his personal wishes. As the user (A) has identified himself to service provider (D), the coupling can be made to the pre-existing payment relationship and the method of configuring the user interface of the obtained device and the purchasable services. Consequently, no new payment relationship will be created for the obtained device, and instead the services taken with the obtained device (20) will be paid for via the pre-existing payment relationship. Also, the service provider is able, using the details already known to him, to configure the user interface of the obtained device (20) and the purchasable services without the need for the user (A) to pass on the configuration or profile he requires for the obtained device. This is shown in FIG. 2 as steps 27 and 28.

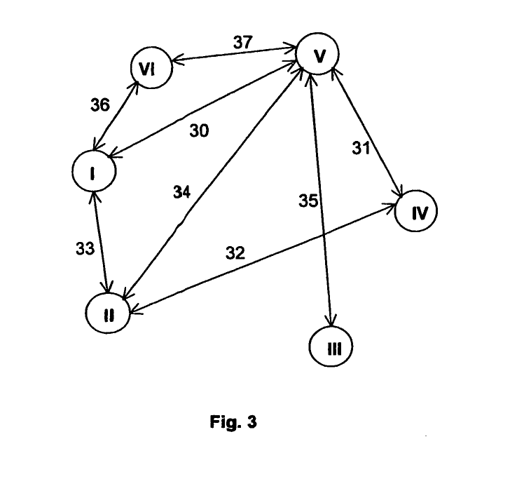

It was stated earlier that the third party (C) and the service provider (D) may be the same, but they may also be organizationally or economically independent of each other. In general, however, the situation is that parties A, B, C and D are able to fulfill different roles that may or may not correspond with one or more parties A . . . D. FIG. 3 shows an example of these different roles and their interrelationships. The roles concern a user (I), a device supplier (II), a network access provider (III), a device configuration provider (IV), a service provider (V) and a settlement provider (VI). The relationships between the roles identified in this example may be as follows:

relationship (30) concerns communication of a desired profile by the user (I) to the service provider (V). This profile may contain, for example, details of the services that user (I) wishes to use by means of one or more devices obtained by him. Also, a notification can take place as part of this relationship (30) in which the user (I) notifies the service provider (V) that he has obtained a device and gives the service provider (V) the unique network identifier of the device;

relationship (31) concerns the device configuration provider (IV) who configures the device according to the specifications of service provider (V), so that on activation the device searches for contact (automatically or with user intervention) with service provider (V). It is also possible that the device configuration provider (IV) will configure the device in a way such that on activation the device searches for contact with one or more network access providers (III);

relationship (32) concerns configuration of the device by the device configuration provider (IV) for supplier (II);

relationship (33) concerns the user (I) obtaining the device from the supplier (II);

relationship (34) concerns the option whereby the supplier (II) notifies the service provider (V) that the device has been supplied to the user (I) with a unique network identifier. However, this action will more typically occur as part of relationships 30 or 36 and 37;

relationship (35) concerns determination of the network identifier by the network access provider (III), on the basis of which the service provider (V) communicates with the obtained device. This communication concerns a user interface/front-end for the obtained device and the purchasable services, based on the desired profile made known by the user (I) in relationship 30;

relationship (36) concerns the option whereby the user (I) notifies the settlement provider that he has obtained a device and informs the settlement provider of the unique network identifier of the obtained device and indicates the pre-existing settlement relationship he wishes to use to pay for services taken with the obtained device;

relationship (37) concerns communication between the settlement provider (VI) and the service provider (V). This relationship has already been explained at length at FIG. 1A.

1. Method for simplifying the activation of an obtained device to allow a user to take services from a service provider by coupling a network identifier of the obtained device to details of the user already known before the activation.

2. Method according to claim 1, whereby the simplification concerns payment for services taken by the user from the service provider, with such payment taking place by means of a pre-existing independent payment relationship as known to exist prior to the obtained device being used to take services from the service provider, and by coupling the network identifier of the obtained device to the user's details recorded in the pre-existing payment relationship.

3. Method according to claim 2, whereby the independent payment relationship already exists with the service provider as a result of a previously obtained device usable to take services from the service provider and for which payment takes place via this payment relationship.

4. Method according to claim 3, whereby the service provider receives the user's details and the network identifier of the obtained device, enabling services taken from the service provider by the user by means of the obtained device to be paid for via the pre-existing payment relationship based on the previously obtained device.

5. Method according to claim 2, whereby the independent payment relationship exists with a third party who is independent of the service provider.

6. Method according to claim 5, whereby the third party receives the user's details and the network identifier of the obtained device and the third party indicates to the service provider that payment for services the user takes from the service provider by means of the obtained device with this network identifier will take place via the pre-existing payment relationship with the third party.

7. Method according to claim 5, whereby the service provider receives the user's details and the network identifier of the obtained device, and the service provider indicates to the third party that payment for the services the user takes from the service provider by means of the obtained device will take place via the pre-existing payment relationship with the third party.

8. Method according to claim 5, whereby the third party is a second service provider, independent of the service provider, from whom the user takes services by means of a previously obtained device.

9. Method according to claim 5, whereby some of the services the user takes from the service provider by means of the obtained device are paid for by means of the pre-existing payment relationship, and other services via a second pre-existing payment relationship.

10. Method according to claim 9, whereby payment for some of the services paid for via the pre-existing payment relationship and others paid for via a second pre-existing payment relationship is based on a breakdown between private use and business use of the obtained device.

11. System for simplifying activation of an obtained device to allow the user to take services from a service provider, consisting of means for coupling a network identifier of the obtained device to details of the user already known prior to activation.

12. System according to claim 11 for payment of services taken by a user from a service provider by means of the obtained device, consisting of means for making such payment via an independent pre-existing payment relationship known prior to the services being taken, and means for coupling a network identifier of the obtained device to details of the user recorded in the pre-existing payment relationship.

13. System according to claim 12, whereby means exist for paying for some of the services taken by the user from the service provider via the pre-existing payment relationship and other services being paid for by means of a second pre-existing payment relationship.

14. Device for which the user pays for services taken from a service provider by means of a pre-existing payment relationship, because a coupling exists between the user's details recorded in the pre-existing payment relationship and a network identifier of the device.

15. Method according to claim 1, whereby the simplification concerns the configuration of a user interface of the obtained device and the services to be taken with it via a network, on the basis of a preferred user profile known before activation of the device, including at least the following steps:
receiving via the network the network identifier of the obtained device on activation of the device;
coupling in a database of the service provider of the network identifier of the obtained device to the details of the user;
coupling in a database of the user's details to the preferred profile;
sending to the obtained device via the network the preferred profile together with the network identifier, so as to configure the user interface of the obtained device in accordance with the user's preferences.

16. System according to claim 11, whereby the simplification concerns the configuration of a user interface of the obtained device and the services to be taken with it, on the basis of a preferred profile of the user known prior to activation of the device, including at least:
a network to which at least the obtained device with a network identifier and a server are connected;
means for receiving, via the network, the network identifier of the obtained device on activation of such device;
a database containing at least the personal details and preferred profile of the user that are accessible by means of the network identifier of the obtained device;
means for sending, via the network, the preferred profile to the obtained device with the network identifier.

17. System according to claim 16, whereby the network over which the obtained device takes services is a different network to the one via which the obtained device is configured.

18. Device for which the user interface and the services to be taken with the device are configured according to the method of claim 15.

19. Device for which the user interface and the services to be taken with the device are configured according to the system described in claim 16.

20. Device for which the user interface and the services to be taken with the device are configured according to the system described in claim 17.
